(19) United States
(12) Patent Application Publication
(10) Pub. No.: US 2024/0109491 A1
(43) Pub. Date: Apr. 4, 2024

(54) APPARATUS FOR UNIVERSAL REPLACEMENT OF AN AUTOMOTIVE REARVIEW MIRROR ASSEMBLY

(71) Applicant: Philip Maeda, Torrance, CA (US)

(72) Inventor: Philip Maeda, Torrance, CA (US)

(21) Appl. No.: 17/955,715

(22) Filed: Sep. 29, 2022

(51) Int. Cl. B60R 1/04

(52) U.S. Cl. CPC B60R 1/04

(57) ABSTRACT

Apparatus that allows aftermarket rearview interior mirror to be mounted to any manufacturer installed mirror mount. A ball and socket system with multiple inserts of different sizes are provided and adapted to be mounted to any size rearview mirror installed in the manufactured vehicle.

### BACKGROUND OF THE INVENTION

### 1. Field of the Invention

The current invention is an apparatus for the quick and easy replacement of the factory installed rearview mirror in a vehicle. All currently manufactured red vehicles are equipped with variety of rearview mirror fixture systems, with no standardized attachment designs specifications. The invention overcomes the need for specialized parts and multiple fixtures or custom fabrication of part that would be required if the original equipment rearview mirror that may or may not built-in enhancements to aid the driver of said vehicle including ability to add external equipment such additional memory and a tele-communication modem. The system would allow replacement of original rearview mirror with a universal, or “ono step”, solution to this problem said without damaging the mirror mount or the windshield. The system utilized the factory installed original rearview mirror mounting system regardless of its size or how it is affixed to the windshield or frame of the vehicle.

### 2. Description of the Prior Art

For years the automotive aftermarket has struggled with the replacement of rearview mirrors in vehicles. The replacement of these mirrors bag become more co on and sought after as the replacement mirrors can contain a variety of electronics that enhance the safety or convenience of the vehicle's functions. Those systems often include several interfaces that can be helpful in die safe operation of said vehicle. A few examples of what systems can be added in these aftermarket mirrors follows:
Video screens that can be contained in one area or the replacement mirror or can be the entire surface of that mirror.
Video screens that display the rear for backing up connected to backup cameras
Video screens that display the side angles for lane changes.
Video screens that display multiple areas exterior and interior of the vehicle.
GPS based navigation system and vehicle locator.
Voice activated testing communication system.
Drive recorders and cameras.
Bluetooth devises for hands free calling.
Video surveillance for the parked vehicle.
Information displays for direction, temperature, speed and collision avoidance.
Extra storage device (solid-state drive) and communication apparatus (modem) with extended cable, or pig tail, attached to the replacement mirror

Because of these and other advanced system that can be added to a vehicle, the rearview mirror is very suitable both in its position in the vehicle as well as net having to install other items such as video screens elsewhere in the vehicle. These features make replacing the factory installed mirror very attractive to consumers.

The issue at hand is there are many different styles mad sizes of these factory installed mirrors and the mounding structures vary with every manufacturer causing many problems associated with this type of mirror replacement. For one example, the way the mirror or mirror mount is affixed to the vehicle are different by models and makes. Some can be attached to the frame of the vehicle but typically they are affixed to the windshield or windscreen of the vehicle. These factories installed system either slide into a “shoe” or structure that is directly affixed to the windshield glass of the vehicle. This shoe or receivers, would need to be replaced and removed from the glass in order to add a different one that would support the new rearview mirror apparatus. This is hard and dangerous as it is very easy to break the glass of the windshield trying to remove and replace the structure often resulting in hundreds of dollars in damage to the vehicles.

In some cases, there is no mounting structure or shoe and the metal mount of the rearview mirror is directly affixed to the ceiling so embedded with headliners. If the moaning structure of the factory installer mirror is directly attached, there is often no choice and it must be cut off to be removed regardless of the risk of damage involved.

Aftermarket mirror manufacturers have tried to adapt to the factory installed shoe, or mount, by fabricating many different mounting structures or bike that would have the ability to be mounted to the shoe (or mount) that is affixed to the glass. This solved the problem of not having to remove the shoe from the glass but this, in turn, generates a new set of problems that teed to overcome. The factory installed shoe and mounts varies with every manufacturer so that many replacement mounts would have to be designed and purchased separately based on the vehicle and mounting requirements. This would requite the installing party to keep on hand several (if not dozens) of different mounting brackets based on the vehicle's manufacturer, model, and even color to match the interior of said vehicle. This is very impractical for both the manufacturer of the replacement mirror as well as those who install the mirror. There are also other concerns, such as the length of these adaptor brackets as well as the angle and pitch.

The obvious solution is to incorporate a system that would allow the manufacturers installed bracket to be used in the replacement of any rearview mirror. This is also challenging as different manufacturer uses a different size and style of ball mount on their mirror brackets. The ball and socket systems allow the driver to position the mirror to best fit his/her seating arrangement height, distance from the rearview mirror and at a desired viewing angle. It must have the ability to be moved by the driver yet strong enough as to not change the view that otherwise could be caused by vibration or normal driving conditions in a factory installed rearview mirror bracket these ball and socket designs varies in size so an additional problem arises of adding the correct size ball and socket to the aftermarket mirror. The invention solves these issues and allows one, or a universal, system to be used to attach an aftermarket mirror to any vehicle.

### SUMMARY OF THE INVENTION

The present invention provides a new apparatus that allows aftermarket mirrors to be easily mounted to any manufacturer installed factory mirror mount. The system utilizes a hall and socket with multiple inserts of different sizes that can adapt to arty size mirror mount ball within the vehicle. The adjustable ball and socket approach with differing socket sizes will securely attached to the factory installed fixture. The socket chosen can then be tightened by a retaining mechanism or compression fitting that wilt secure the coupling regardless of the size of the originally installed socket. The socket then can be affixed to the aftermarket mirror (or mirrors) to complete mounting the new mirror. This approach would allow the use of the manufacturers installed mounting system thus solving many problems faced by prior art rearview mirror replacements.

The new mirror retains the height and position of the factory mirror within the vehicle at the optimum position.

The factory mounting structure can be used so that an aftermarket structure would not need to be produced, stocked and purchased in, various sizes, lengths and hall types to facilitate the replacement of the factory mirror.

The factory mirror mount would not have to be removed from the windshield of the vehicle possible causing damage to the windshield and costs involved replacing it. This is far too common and restricts some installers form even attempting this type of rearview Mirror replacement.

The present invention thus provides a single, or universal, system for most, if not all, factory installed rearview mirror replacement without the need for additional fabricated parts or a large variety of mounting brackets to be kept on hand for the many different sizes of replacement housings that would be needed.

The present invention thus eliminates most of the obstacles faced when replacing a factory rearview mirror for an aftermarket mirror with many other features and capabilities that would enhance driver safety and convenience.

### DESCRIPTION OF THE DRAWINGS

For a better understanding of the present invention as well as other objects and further features thereof, reference is made to the following description which is to be read in conjunction with the accompanying drawing therein:

FIGS. 1A and 1B illustrate the insertion of the system socket housing fixture into the replacement mirror [is an illustration of the mirror mounting systems and the primary components therein];

FIGS. 2, 3 and 4 illustrates the steps used to complete assembly with the new rearview mirror with the factory installed mirror system;

FIG. 5 illustrates the changeable socket components of the replacement mirror;

FIG. 6 illustrates the replacement housing for the replacement mirror;

FIG. 7 illustrates the ball and socket adaptor and the factory installed mirror housing assembly; [and]

FIGS. 8A and 8C illustrate different sized mount adaptors and FIGS. 8B and 8D illustrate different shaped retaining fixtures associated with the corresponding mounting fixtures [illustrates the various components, sockets and adaptors of the replacement mirror system of the present invention]; and

FIG. 9 illustrates the extension cable attached to the replacement mirror and which is connected to an external memory device (solid-state drive) and a communication equipment (modern) for transmitting vehicle information, including GPS location and voice/text messaging to a remote location.

### DESCRIPTION OF THE INVENTION

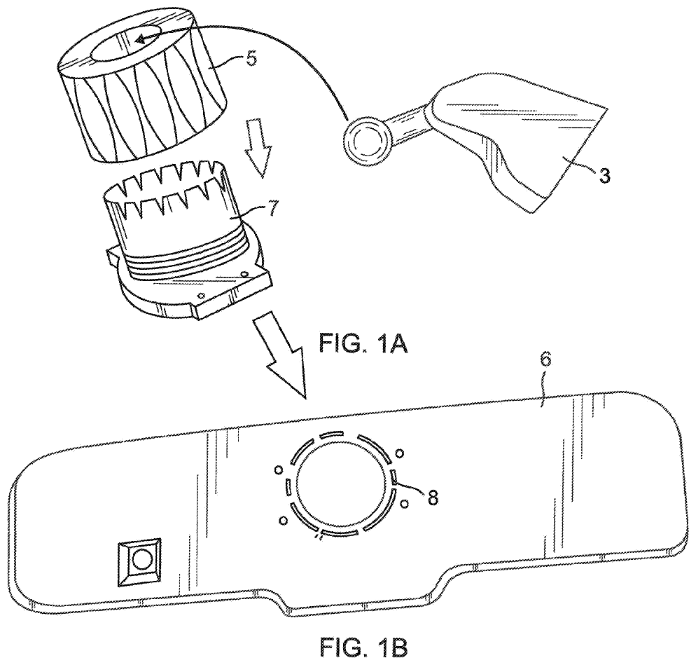

FIG. 1 is an illustration of the components that comprise mirror mounting system 1 of the present invention. Mounting structure 3 from the factory installed rearview mirror is connected to the replacement mirror ball and socket coupling system 8. The ball 11 on the mourning fixture 3 passes through the retaining, or tightening fixture 5 and is inserted into the socket housing 7 attached to the replacement mirror 6 at predefined area having mounting hole 8 formed in the rear surface of replacement mirror 6. The socket position that min be interchanged is positioned between retaining fixture 5 and the socket housing fixture 7 (the interchangeable sockets are not shown in this figure). The retaining fixture 5 and housing fixture 7 screw together to tighten the ball and socket joint providing a secure and adjustable replacement mirror mounting system.

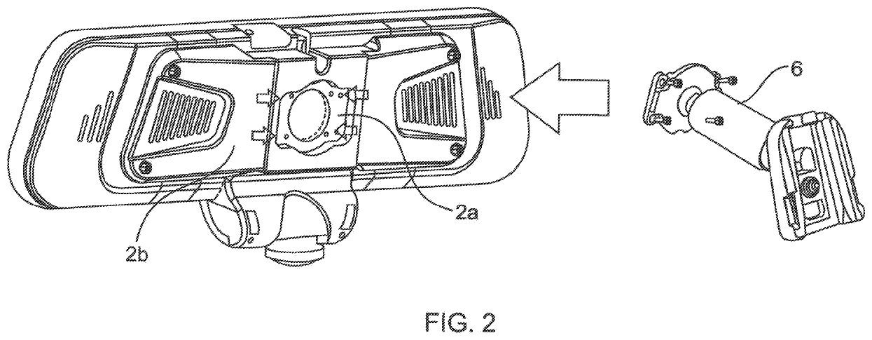

FIG. 2 is an illustrates the mirror mounting system without using the universal mounting mechanism which illustrated as FIG. 1. The mounting system 1 (preferably made with diecast steel or zinc material) has the compatible attachment footprint 2a to attach to the rearview mirror body 2b. Mount 1 is a replacement mount of the present invention (original mount has been removed and is not observed in the figure).

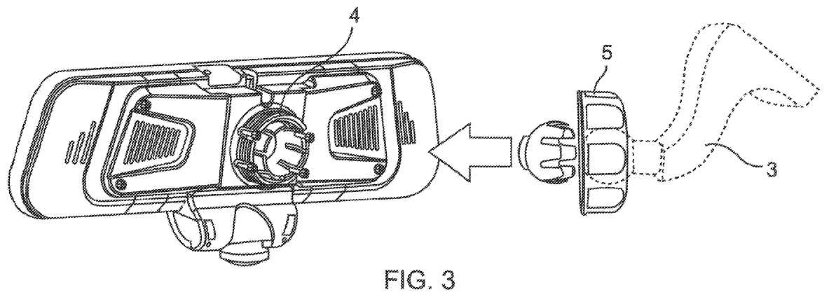

FIG. 3 illustrates the complete assembly of the ball and socket assembly of the present invention. The factory mirror mounting bracket 3 is inserted into the ball and socket of the retaining assembly 5 and housing assembly 4, Components 4 and 5 savvy together and apply resistance to the factory installed ball of the mirror mount and the interchangeable sockets that allows for movement to the angle desired by the vehicle driver but is secured so that it does not move during normal operation.

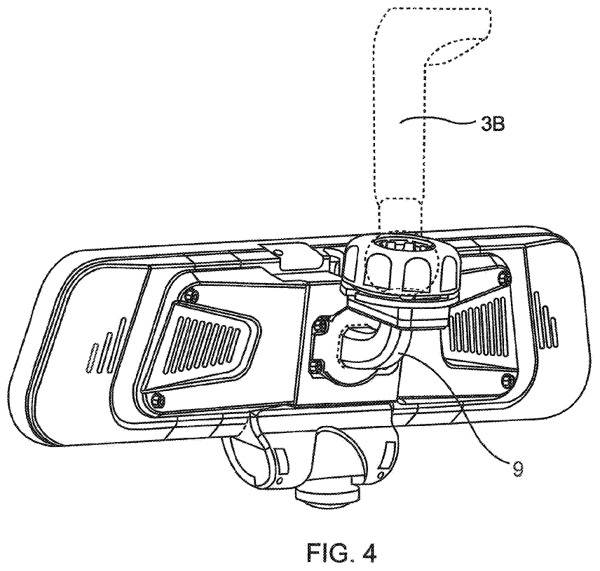

FIG. 4 is an illustration of the mirror mounting system for the factory installed mirror; in this case the ball joint socket is located on top of the mirror instead of more common rear section of a rearview mirror body as shown in FIG. 3, in this type of installation, the original equipment mounting fixture 3b is attached to the vehicle ceiling or headliner instead of the typical windshield attachment location. A L-shaped fixture 9 is provided to enable this type of replacement mirror installation.

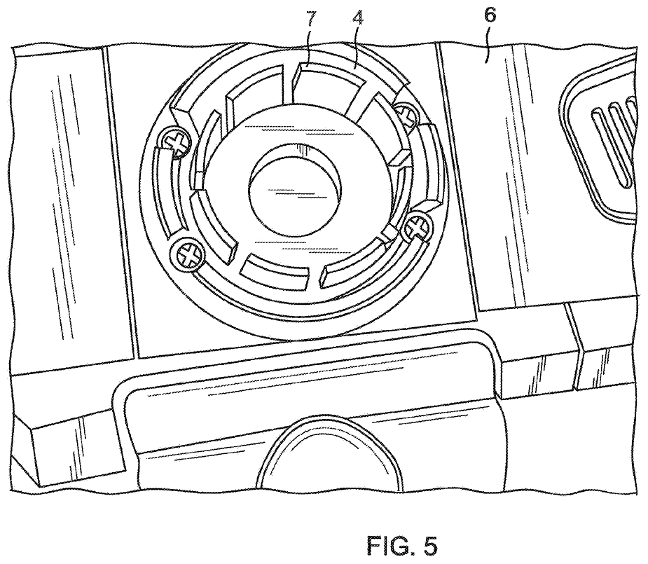

FIG. 5 illustrates an interchangeable socket 7 within the replacement mirror 6. The replacement mirror is shown within the receiver of housing fixture 4.

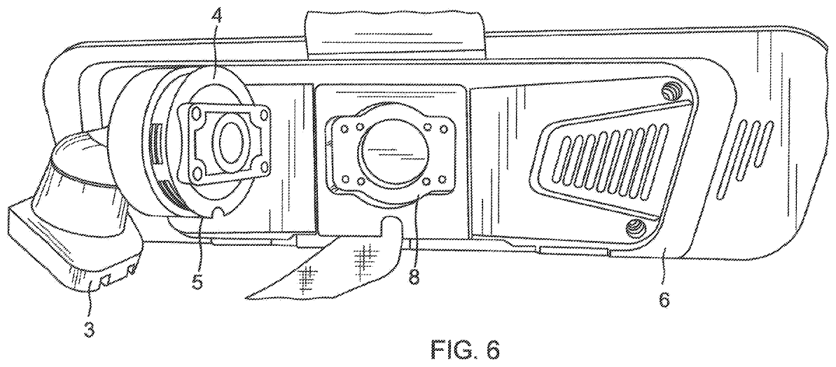

FIG. 6 illustrates the receptacle housing for the replacement mirrors and provides a further understanding of how the system of the present invention operates. The original equipment mirror mount 3 is shown connected to the retaining assembly 5 screwed into the receiver or housing fixture 7 in the position to be connected to the housing area connection point 8 on the replacement mirror 6.

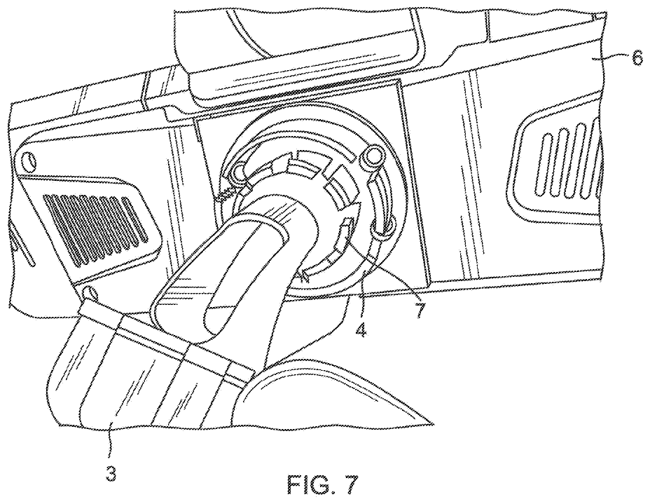

FIG. 7 illustrates the ball and socket adaptor and the factory installed mirror housing assembly. The replacement mirror housing 6 is shown connected to the original equipment mirror mounting bracket 3. The mirror hosing area 4 is shown with one of the interchangeable sockets 7 in it's designated area with the ball of the original mounting bracket 3 already installed.

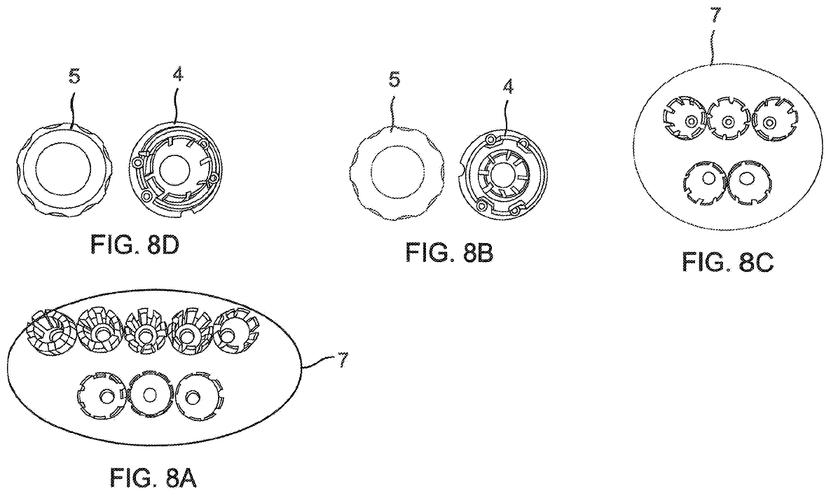

FIG. 8 is a picture of the various components sockets and adapters of the replacement mirror system. The socket housing (or mounting fixture) 4 is shown with the tightening or retaining fixture 5. The figure also illustrates different sized mount adaptors 7 that enables different sized ball joints installed by the factory to be adapted for use by the present invention thus allowing a replacement rearview mirror to use with vehicles having a factory installed mirror effectively providing a universal replacement mirror mounting system.

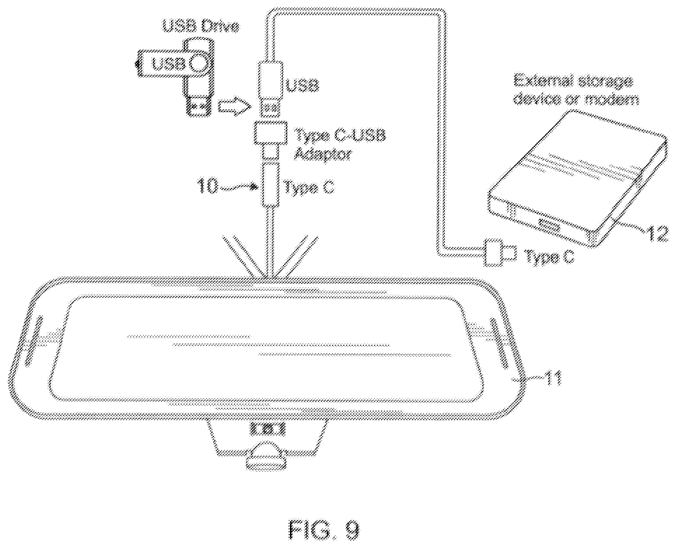

FIG. 9 is a picture of the hardware cable (or pig tail) 10 that is connected to the replacement mirror 11 for addition of various components 12, such as external memory devices (solid state drive) and tele-communication modules 4G/5G/6G thus allowing a replacement rearview mirror to use with vehicles having an external memory storage or communication externally to the cloud server or call center. With the connectivity the replacement mirror device can be connected to cell phones or any other types of mobile device with connectivity wirelessly or wired for emergency or location alerts.

While the invention has been described with reference to its preferred embodiments it will be understood by those skilled in the art that various changes may be made and equivalents may be substituted for elements thereof without departing from the true spirit and scope of the invention. In addition, many modifications may be made to adapt a particular situation or material to the invention without departing from its essential teaching.

What is claimed is:

1. A universal system for the replacement of a factory installed rearview mirror without replacing the factory originally installed mirror mount.

2. A universal system as set forth in claim 1 further including a ball and socket configuration with varying size sockets for use with the mirror mount ball joint component that is part of said installed rearview mirror system.

3. A universal system as set forth in claim 1 wherein a replacement mirrors is attached to said mirror mount ball joint component.

4. A universal system as set forth in claim 3 wherein different sized adaptor components are provided, such adaptor components being attachable to said factory installed rearview mirror.

5. A universal system as set forth in claim 4 further including a cable member for adding an external device to said replacement rearview mirror.

6. A universal system as set forth in claim 5 wherein said external device is, a memory component.

7. A universal system as set forth in claim 5 wherein said external device is a modern.
